(19) United States
(12) Patent Application Publication
(10) Pub. No.: US 2026/0057568 A1
(43) Pub. Date: Feb. 26, 2026

(54) AUDIO AND VISUAL MODIFICATION

(71) Applicant: Nokia Technologies Oy, Espoo (FI)

(72) Inventors: Miikka Tapani VILERMO, Tampere (FI); Leevi LIU, Tampere (FI)

(21) Appl. No.: 19/292,378

(22) Filed: Aug. 6, 2025

(30) Foreign Application Priority Data
Aug. 22, 2024 (GB) 2412385.3

(51) Int. Cl. G06T 11/00; G06T 3/4038; G06V 10/25; G06V 10/40

(52) U.S. Cl. CPC G06T 11/00; G06T 3/4038; G06V 10/25; G06V 10/40

(57) ABSTRACT

There is herein disclosed an apparatus comprising: means for capturing first visual data associated with a first image, means for capturing second visual data associated with a second image, means for capturing spatial audio data from a sound source, means for estimating a first distance of the sound source from the apparatus, means for estimating a direction of the sound source from the apparatus, means for combining at least a portion of the first visual data and at least a portion the second visual data to produce a stitched image by using a transformation parameter, means for modifying the spatial audio data based on the first distance and the transformation parameter to produce modified spatial audio data, and means for outputting the stitched image alongside the modified spatial audio data.

### FIELD

Example embodiments may relate to systems, methods and/or computer programs for generating a stitched image with spatial audio data. Example embodiments may relate to systems, methods and/or computer programs for generating proposed visual data. The embodiments, in particular, relate to adaptation of visual and audio data to account for blind spots.

### BACKGROUND

More recently, image and video capture 360-degree-degree devices are available. These devices are able to capture visual and audio content all around themselves, i.e. they can capture the whole angular field of view, referred to as 360-degree-degrees field of view. More precisely, they can capture a spherical field of view (i.e., 360-degree degrees in all axes).

Furthermore, types of output technologies are also available, such as head-mounted displays. These devices allow a person to see visual content all around him/her, giving a feeling of being immersed into the scene captured by the 360-degree-degrees camera.

The new capture and display paradigm, where the field of view is spherical, is commonly referred to as virtual reality (VR) and is believed to be the common way people will experience media content in the future.

The recent advent of commercial multi-directional image capture apparatuses, such as 360-degree camera systems, brings new challenges with regard to the management of blind spot areas of camera systems in a reliable, accurate and efficient manner.

### SUMMARY

The scope of protection sought for various embodiments of the invention is set out by the independent claims. The embodiments and features, if any, described in this specification that do not fall under the scope of the independent claims are to be interpreted as examples useful for understanding various embodiments of the invention.

According to a first aspect, there is described an apparatus comprising: means for capturing first visual data associated with a first image, means for capturing second visual data associated with a second image, means for capturing spatial audio data from a sound source, means for estimating a first distance of the sound source from the apparatus, means for estimating a direction of the sound source from the apparatus, means for combining at least a portion of the first visual data and at least a portion the second visual data to produce a stitched image by using a transformation parameter, means for modifying the spatial audio data based on the first distance and the transformation parameter to produce modified spatial audio data, and means for outputting the stitched image alongside the modified spatial audio data.

The transformation parameter may comprise a first transformation parameter element for transforming the first image data and/or a second transformation parameter element for transforming the second image data.

The apparatus may comprise means for determining a cross over point where the first image and second image overlap, wherein the means for combining the at least a portion of the first visual data and the at least a portion the second visual data to produce a stitched image is based on the determined cross over point.

Using a transformation parameter may comprise transforming least a portion of the first visual data and/or at least a portion of the second visual data to match the cross over point between the first image and the second image.

The apparatus may further comprise means for determining a second distance, wherein the second distance comprises a distance from the apparatus to the cross over point and means for determining that the first distance is less than the second distance.

The means for estimating the first distance of the sound source from the apparatus may be based on relative volume differences between the plurality of microphones.

The apparatus may comprise a 360-degree camera.

According to a second aspect, there is described an apparatus comprising: means for capturing first visual data associated with a first image, means for capturing second visual data associated with a second image, means for determining at least one aspect of the first visual data and the second visual data that overlap, means for combining the first visual data and the second visual data to produce a stitched image based on the least one aspect, means for determining a region of the first visual data and the second visual data that do not overlap, means for identifying a first feature of the first visual data and/or a second feature of the second visual data in the region and means for generating proposed visual data based on at least one of the first feature and/or the second feature.

The apparatus may further comprise means for updating the stitched image to include the proposed visual data.

The apparatus may further comprise means for capturing spatial audio data from a sound source and means for generating the proposed visual data based on the spatial audio data.

The proposed visual data may be generated by a machine learning model or a database repository.

The proposed visual data may be generated based on previous imagery captured in the region.

The region may comprise an area adjacent to a blind spot area of the apparatus.

The apparatus may comprise a 360-degree camera.

According to a third aspect, there is described a method comprising: capturing first visual data associated with a first image, capturing second visual data associated with a second image, capturing spatial audio data from a sound source, estimating a first distance of the sound source from the apparatus, estimating a direction of the sound source from the apparatus, combining the first visual data and the second visual data to produce a stitched image by using a transformation parameter, modifying the spatial audio data based on the first distance and transformation parameter to produce modified spatial audio data and outputting the stitched image alongside the modified spatial audio data.

According to a fourth aspect, there is described a method comprising: capturing first visual data associated with a first image, capturing second visual data associated with a second image, determining at least one aspect of the first visual data and the second visual data that overlap, combining the first visual data and the second visual data to produce a stitched image based on the least one aspect, determining a region of the first visual data and the second visual data that do not overlap, identifying a first feature of the first visual data and/or a second feature of the second visual data in the region and generating proposed visual data based on at least one of the first feature and/or the second feature.

According to a fifth aspect, there is provided a computer program product comprising a set of instructions which, when executed on an apparatus, is configured to cause the apparatus to carry out the method of any preceding method definition.

According to a sixth aspect, there is provided a non-transitory computer readable medium comprising program instructions stored thereon for performing the method of any preceding method definition.

### BRIEF DESCRIPTION OF THE DRAWINGS

Example embodiments will now be described by way of non-limiting example, with reference to the accompanying drawings, in which:

FIG. 1 shows, by way of example, a 360-degree camera device.

FIG. 2 shows, by way of example, an illustration of a 360-degree camera view angles.

FIG. 3A shows, by way of example, an illustration of a 360-degree camera view angles.

FIG. 3B shows, by way of example, an illustration of how an image may be stitched from 360-degree camera view angles.

FIG. 4 shows, by way of example, blind spot area of a 360-degree image.

FIG. 5 shows, by way of example, a graph of how visual objects images may be stitched together.

FIG. 6 shows, by way of example, a flowchart of a method.

FIG. 7 shows, by way of example, a graph of audio modification based on visual images.

FIG. 8 shows, by way of example, a further graph of audio modification based on visual images.

FIG. 9A shows, by way of example, an illustration of a 360-degree camera view angles.

FIG. 9B shows, by way of example, an illustration of how an image may be stitched from 360-degree camera view angles.

FIG. 10 shows, by way of example, an illustration of a 360-degree camera view angles including a person located in or near a blind spot.

FIG. 11A shows, by way of example, an illustration of a person. FIG. 11B shows, by way of example, an illustration of how an image may be stitched from 360-degree camera view angles. FIG. 11C shows, by way of example, an illustration of how an image may be stitched from 360-degree camera view angles including new proposed visual data.

FIG. 12 shows, by way of example, a flowchart of a method.

FIG. 13A shows, by way of example, an illustration of a first image and a second image. FIG. 13B shows, by way of example, an illustration of how an image may be stitched from 360-degree camera view angles.

FIGS. 14A-14D shows, by way of example, an illustration of how an images may be stitched from 360-degree camera view angles.

FIG. 15 shows a computer apparatus according to some example embodiments.

FIG. 16 shows a non-transitory media according to some embodiments

### DETAILED DESCRIPTION

The disclosure herein is related to 360-degree cameras that create 360-degree images using multiple camera sensors and lenses. The disclosure herein also relates to creating spatial audio data using at least two microphones and/or creating generating proposed visual data. In particular, the disclosure is directed to mitigating blind spots that are present in the images generated by 360-degree cameras.

Getting sound directions to match video directions is important and it is even more so important with the continued evolution of 360-degree videos. 360-degree video and stills are often viewed with head mounted wearable devices with head tracking and in such scenarios discrepancies between visual and audio output can ruin the user's immersion. There are many use cases where sound and visual directions, and in particular, close-by sound and visual directions need to be correct. For example, one use case is industrial sound analysis that is used to detect faults and potential faults in engines and machines. For this, sound often needs to be recorded from inside the machine where a 360-degree camera would be very useful in giving a view to all directions and in fact 360-degree cameras are often used for remotely solving industrial problems. A further example use case is autonomous sensory meridian response (ASMR) videos that are now commonplace when using the internet and in multimedia environments. While recording ASMR videos, the sound sources are often brought very close to the recording device to enhance the effect. 360-degree ASMR videos are designed produce heightened immersion and discrepancies between sound and video may ruin the ASMR effect.

Creating spatial audio with multiple microphones in a 360-degree camera with multiple camera sensors has been achieved, such as with the Nokia OZO™ camera. However, there is a desire for improved correction of sound or visual directions for near-by objects which may fall into the blind spots of cameras. The blind spots are present based on the view angle of camera and the overlap present between cameras (or lack of overlap). Blind spot interference in 360-degree degree camera can depend on object distances and/or positions of the camera sensors.

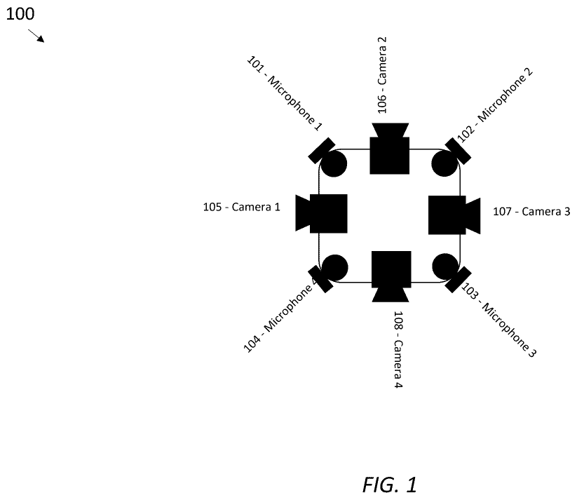

FIG. 1 illustrates a 360-degree camera device 100 from a birds-eye perspective. The device 100 includes four microphones 101-104 and four cameras 105-108. Although the device 100 is shown with four microphones 101-104 and four cameras 105-108, the device 100 may only have two microphones and two cameras in the most simplified form (not shown). Additional microphones and camera may also be present in a more complex camera device set up. Furthermore, additional sensing equipment may also be present on the device. The microphones 101-104 are used to capture spatial audio data. The spatial audio may be in any format from which audio directions can be heard, for example, such as binaural, stereo, 5.1, 7.2, and parametric spatial audio format. Converting microphone signals into these formats may be conducted via conventional known means. The cameras 105-108 are used to capture visual data including still images or videos using visible light. The images, videos and spatial audio may be stored on memory present on the device 100 or sent to a remote location for storage. Other sensing equipment may also be present to capture infrared light or specialist equipment for nighttime use.

The device 100 has a physical size because the microphones 101-104, cameras 105-108 and additional components such as a processor and memory all take up physical space. Therefore, the microphones 101-104 and cameras 105-108 are separated by some distance apart from each other, as demonstrated in FIG. 1. As a result of this, and as will be demonstrated further, the area each camera sees doesn't overlap in an area near the device. Instead, the area each camera sees only overlap after a distance that may be referred to as a cross-over point.

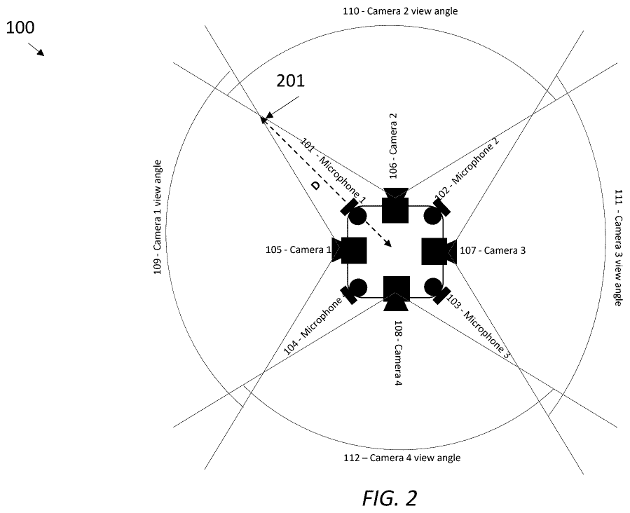

FIG. 2 shows the field of view of each of the cameras 105-108 of FIG. 1. The field of view for camera 1 105 is shown by camera 1 view angle 109, and respective fields of view for cameras 2-4 106-108 are shown by each of camera 2-4 field of views 110-112 respectively. By way of example, a cross-over point 201 is marked in FIG. 2 for the point at which the field of view angle 109 for camera 1 105 and the field of view 110 for camera 2 overlap. A distance, D, is marked in FIG. 2. The distance, D, shows the distance from the centre of the device 100 to the cross-over point 201.

In reality, a cross-over point may be a cross-over line, rather than a fixed point in space, since 360-degree images are 3-dimensional. The cross-over point may extend along a cross-over line and may be curved in shaped. For simplicity, FIGS. 1 to 3 focus on horizontal plane by way of demonstration. By way of example, in typical 360-degree devices the cross-over point may be approximately a meter away from camera centre.

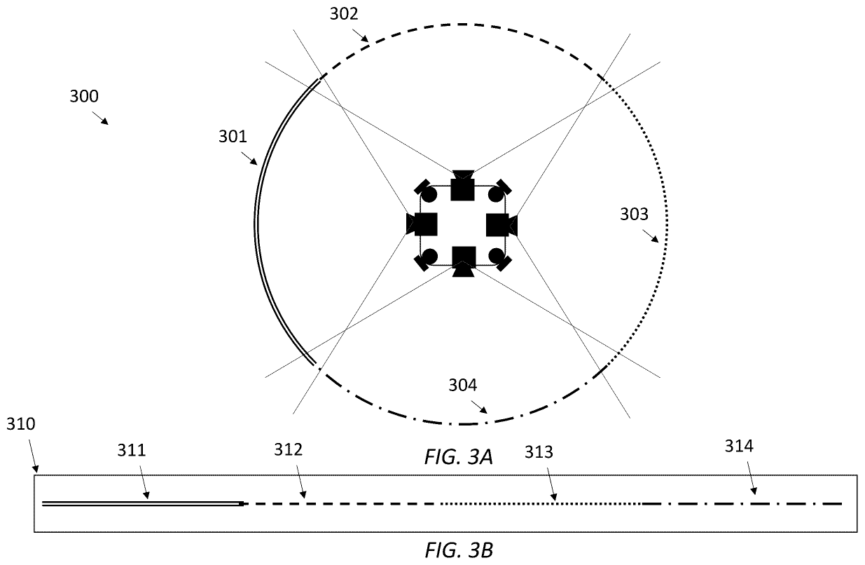

A final 360-degree camera image is generated by stitching together images from each of the cameras 105-108 of a device. FIGS. 3A and 3B show how a stitched image may be generated from the example configuration discussed herein. By way of representation, fields of view of respective cameras are shown by the dotted and dashed lines in FIGS. 3A and 3B. In FIGS. 3A and 3B, the dotted and dashed lines sectors represent approximately how each camera image is used for a final 360-degree image, where field of views are shown as marked by the reference numerals 301-304 in FIG. 3A and the corresponding final image 310 is shown in FIG. 3B as stitched combination of the images taken in each field of view for each camera. Each image of the field of field as stitched together in a final image 310 are shown by reference numerals 311-314. FIG. 3B shows the corresponding sectors (as labelled with the dotted and dashed lines) in equirectangular format. The stitched final image 310 is produced by transforming the individually captured images from each of the cameras. Corresponding features of the individually captured images may be identified and used to determine where the stitching of images should take place.

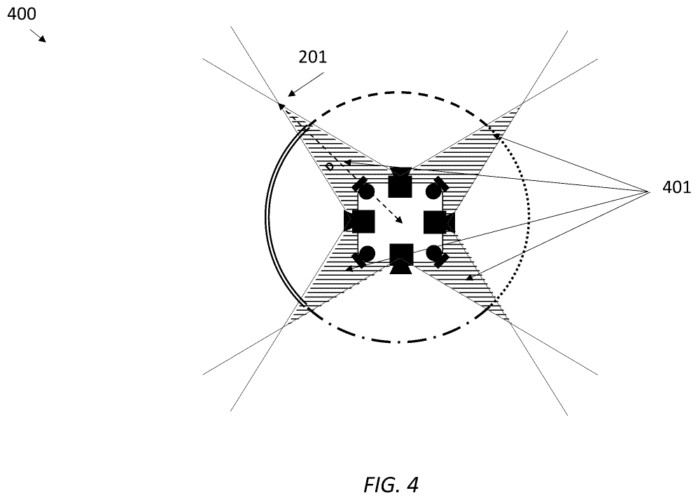

As demonstrated in FIG. 4, when objects are near-by to a device 400, the camera cannot see them in the whole 360-degree circle due to blind spot areas 401 present due to the field of view. The blind spot areas 401 are only present within a close proximate distance of the device 400 since the field of view of each camera is not wide enough to cover the whole area close to the device 400 and because it is not practical or economically viable to have enough cameras on the device 400 to avoid the blind spot areas 401. The blind spot areas 401 exist between the device 400 and the cross over point 201. Beyond a certain distance, D, from the device 400, the blind spot areas 401 no longer exist. The distance, D, may be calculated from the centre of the device 400 or from an external point on the device 400, such as from a particular microphone (not shown).

The image stitching process as demonstrated in FIGS. 3A and 3B does not take the blind spot areas 401 into consideration when producing a final image. Instead, the stitched image is made from only the data that each camera on the device 400 is capable of collecting. This results in the image data of the blind spot areas missing from the stitched image. The proportion of the stitched image that is affected by this depends on the view angles and camera size. Generally, the proportion of an environment which is within a blind spot cannot be made so small that the effect on the image is insignificant. As a result, in the stitched image, near-by visual object directions may not match to object actual directions. Furthermore, sound data taken from the microphones may accordingly not match with the stitched image, since audio data may be captured for something which is present in the blind spot area and therefore does not appear in the stitched image.

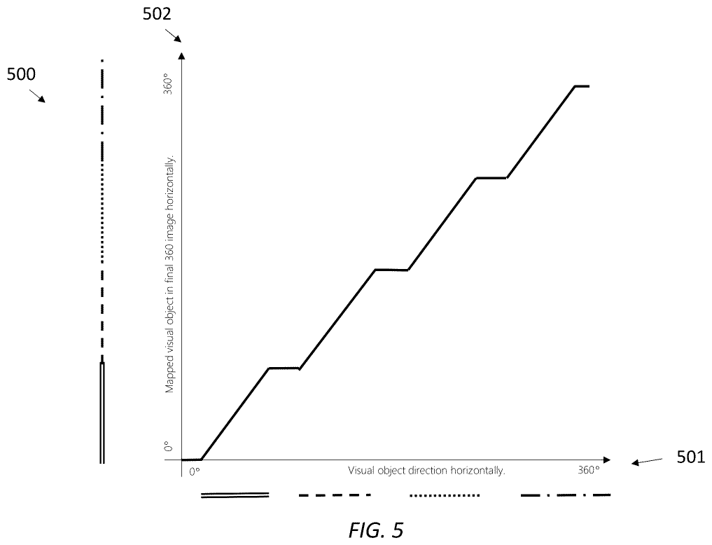

FIG. 5 depicts a representation 500 of this problem in graphical format. FIG. 5 shows an example of how visual object images may be stitched together in a stitched image. This representation 500 applies only to the portion of a stitched image that this within a distance that is less than the cross over point 201, such that the blind spot areas 401 are present. The x-axis 501 shows a representation of the image coverage for the fields of view of four different cameras (as shown by the dotted and dashed lines shown in FIG. 3). At some angles there is no image data available. The y-axis 502 shows the mapped visual representation in the final 360-degree image. The blind spot areas 401 are ignored and the image coverage for the fields of view of the four different cameras that have been stitched together. The stitched image shown has missing portions between adjacent individual images. Such a problem only exists within close proximity of the device and does not exist beyond the cross over point 201 of the fields of view of adjacent cameras.

The disclosure herein provides two solutions for addressing the highlighted problem. A first solution, referred to as the ‘modify audio’ solution, is provided to adapt audio data obtained from a device to counteract the effects of the problem. A second solution, referred to as the ‘modify video’ solution, is provided to adapt or produce visual data to counteract the effects of the problem. Both solutions provide an improved solution for generating 360-degree visual and audio data for a stitched image. Both solutions are designed for use within close proximity of a device, which is where the blind spot area effects are observed. Each of the ‘modify audio’ solution and ‘modify video’ solution can be applied independently of each other, or a combined solution may include both solutions used simultaneously.

The proposed solutions both use an apparatus with two or more camera sensors that stitches the multiple camera sensor image together for a stitched image. The apparatus also records spatial audio with two or more microphones characterized in that the spatial audio directions or directions of visuals are modified for close-by audiovisual sources so that audio directions are a better match for visual directions in the stitched image.

### Modify Audio Solution

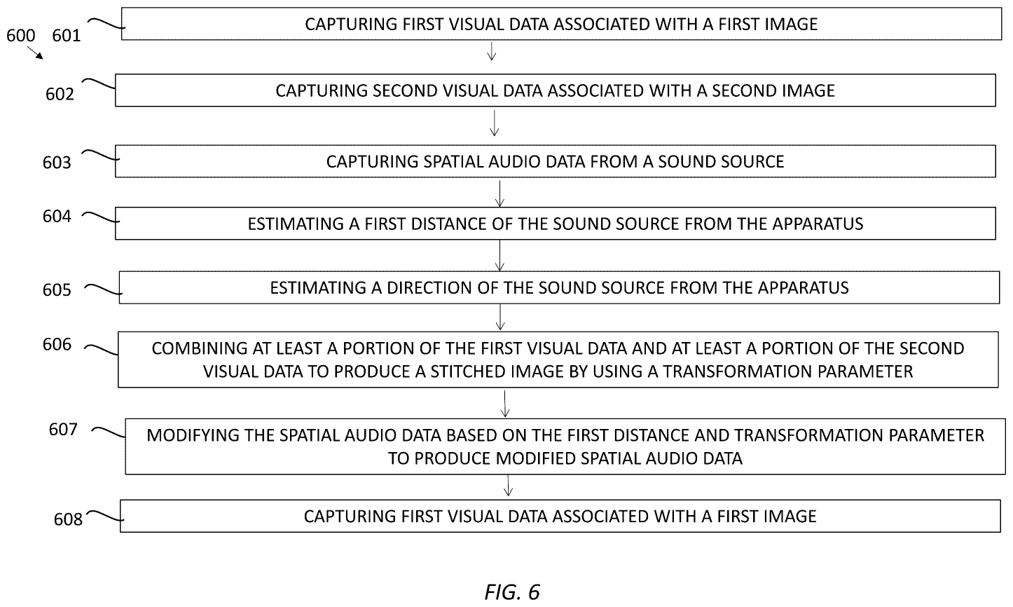

FIG. 6 shows, by way of example, a flowchart of a method according to example embodiments. Each element of the flowchart may comprise one or more operations. The operations may be performed in hardware, software, firmware or a combination thereof. For example, the operations may be performed, individually or collectively, by a means, wherein the means may comprise at least one processor; and at least one memory storing instructions that, when executed by the at least one processor, cause the performance of the operations.

The method 600 of FIG. 6 may be carried out by an apparatus such as the device shown in FIGS. 1 to 4. The apparatus may comprise a 360-degree camera. The apparatus may also include any panoramic or such cameras which utilize stitching images from more than one image sensors.

The method 600 comprises a first operation 601 of capturing first visual data associated with a first image. The first visual data may be captured by camera 1 105 with field of view 109. The first image may comprise a still picture or video imagery.

The method 600 comprises a second operation 602 of capturing second visual data associated with a second image. The second image may comprise a still picture or video imagery. The second visual data may be captured by camera 2 106 with field of view 110. The field of view 109 and the field of view 110 have a cross over point 201 and there is a blind spot area 401 in an area proximate to the apparatus.

In some embodiments, the first visual data and second visual data may be collected via a single physical image sensor. The image sensor may be divided into more than one logical sensors, each having dedicated optics, which would result in stitching multiple images to form a single image.

The method 600 comprises a third operation 603 of capturing spatial audio data from a sound source. The spatial audio data can be captured by microphone 1 101. The sound source can be any feature that is present in the vicinity of the apparatus such as, but not limited to, a person, a vehicle or an animal. Furthermore, the spatial audio data may be captured by a plurality of microphones, such as microphones 1 to 4 101-104. The spatial audio data can be pieced together from multiple microphones and as such the spatial audio data includes information about the direction of the sound source.

The method 600 comprises a fourth operation 604 of estimating a first distance of the sound source from the apparatus. Estimating the distance of the sound source is an important step in the method 600 and may be done via sound analysis from audio data obtained from at least two of the plurality of microphones. Estimating of the distance of the sound source from the apparatus may be conducted by determining direction-of-arrival (DOA) of sound waves and distance relative to a microphone or plurality of microphones. When there are at least two microphones, the volume level difference in different microphones can be used. The closer the sound source is to the device, the more there is likely to be volume level difference between microphones, because there is a bigger relative difference in the distance between the sound sources. As such, estimating the first distance of the sound source from the apparatus may be based on relative volume differences between the plurality of microphones.

The ‘modify audio’ solution may be implemented depending on distance of the sound source from the apparatus. If the distance is greater than a cross-over point distance determined for the apparatus, then no audio modification is required since no blind spot areas are present and the sound source will be present within the visual data captured by the apparatus. If the distance is less than the cross over point distance determined for the apparatus, then audio modification may be required since the sound source could be located within the blind spot areas and therefore the sound source may not be present within the visual data captured by the apparatus. As such, the method 600 may also comprise determining a cross over point where the first image and second image overlap. The method may further comprise determining a second distance. The second distance comprises a distance from the apparatus to the cross over point. The method may further comprise determining that the first distance is less than the second distance and subsequently determining that audio modification is required.

The method 600 comprises a fifth operation 605 of estimating a direction of the sound source from the apparatus. The direction of the sound source from the apparatus may be done via similar means as discussed in relation to the distance via the use of multiple microphones. Indeed, via distance and DOA analysis an exact location of the sound source in 3D space may be discovered by virtue of estimating both the distance of the sound source from the apparatus and the direction of the sound source from the apparatus.

The ‘modify audio’ solution may be implemented depending on the direction of the sound source from the apparatus. The method may optionally include pre-determining zones where the blind spot areas are present. These zones may be determined based on the blind spot areas and angles at which it is known that the blind spot areas exist. If it is determined that the sound source is present at an angle for which no blind spot areas exist, then no audio modification is required, since no blind spot areas are present and the sound source will be present within the visual data captured by the apparatus. If it is determined that the sound source is present at an angle for which blind spot areas do exist, then audio modification may be required since the sound source could be located within the blind spot areas and therefore the sound source may not be present within the visual data captured by the apparatus.

The method 600 comprises a sixth operation 606 of combining at least a portion of the first visual data and at least a portion the second visual data to produce a stitched image by using a transformation parameter. The stitched image is produced by aligning the first visual data and the second visual data which may be from neighboring camera sensors and combining the first visual data and second visual data by using a transformation parameter. In some examples the whole of the first visual data and second visual data may be combined, or alternatively, only portions of the first visual data and second visual data may be combined (such as those part of the first and second visual data which are closest to a blind spot). The transformation parameter may be a set of predefined transformation parameter values. Using a transformation parameter may comprise transforming at least a portion of the first visual data and/or at least a portion of the second visual data by the transformation parameter. Transforming at least a portion of the first and second visual data may include only adjusting or adapting a portion of the first and second visual data. In such a scenario, the another portion of the first and second visual data may remain unchanged in the stitched image or could be discarded from the stitched image. As shown in FIG. 5 visual data captured by four camera sensors, each adjacent to two neighboring sensors, is transformed to form one optically coherent stitched image. The transformation parameter comprises, among other values, a set of calibrated relationship values, which define both the physical and the optical relationships between each camera sensor and neighboring camera sensors.

The transformation parameter comprises a first transformation parameter element for transforming the first image data and/or a second transformation parameter element for transforming the second image data. The first and second transformation parameter element may include different values based on the physical and the optical relationships between each camera sensor and neighboring camera sensors.

The method 600 comprises a seventh operation 607 of modifying the spatial audio data based on the first distance and the transformation parameter to produce modified spatial audio data. The transformation parameter used to transform at least a portion of the first visual data and/or at least a portion of the second visual data is also used to modify the spatial audio data. In other words, the modification to the spatial audio data needs to be similar to the modification to the first and second visual data. The transformation parameter is designed to modify the spatial audio data such that the apparent direction of the sound source from the apparatus is adjusted in the modified spatial audio data. The transformation parameter may shift at least a portion of the spatial audio data by the exact same transformation parameter as used to produce the stitched image.

The modification of the audio data is straightforward if the audio is in parametric spatial audio format where the audio direction is an angle parameter that may be modified directly. Other spatial audio formats may be converted into a parametric format where modification takes place after which audio is converted back into the original spatial audio format. Also, audio formats that use audio objects with direction parameters can be converted simply by modifying the parameter. And other audio formats may be converted into objects and modified similarly.

The modification of the spatial audio data may be stronger the closer the sound is to the apparatus. As such, a smaller distance from the sound source to the apparatus will require a relatively greater amount of audio modification than a larger distance from the sound source to the apparatus. The audio modification must be greater the closer the sound source is to the apparatus because, the blind spot area is larger closer to the apparatus than it is at the cross over point. As such, a greater degree of modification is required to account for the greater distance from the sound source to the captured visual data.

Modifying the spatial audio data may comprise modifying various components of the audio. Modifying the spatial audio data may comprise changing at least one feature of the audio. The at least one audio feature may comprise at least one of the following: volume, perceived direction, balance, equalization parameters, direction parameters, ratio parameters such as direct-to-ambient ratio, inter-channel level difference, inter-channel time difference.

Further options for modifying the audio feature may include:
Time: For example, a delay may be added to one or more of channels of spatial audio such that the perceived direction of the sound source changes.
Level: For example, level may be modified in one or more of the channels such that the perceived direction of the sound source changes.
Panning: For example, placing tracks in the left or right channel. This may create an effect that makes it sound like the sound source are coming from different directions.
Direction parameter: direction parameters may be modified directly.
Ratio parameter: Direct-to-ambient ratio may be reduced by changing the ratio parameter to a smaller value to make audio direction less apparent.

Modifying the direction of spatial audio data can be done when the spatial audio data is in parametric audio format. Analysed audio direction azimuth parameter may be modified according to the same parameters as used to modify visual data or by similar values from a look-up table. Modification can be done similarly for elevation parameter. The modification needs to be audio source distance dependent.

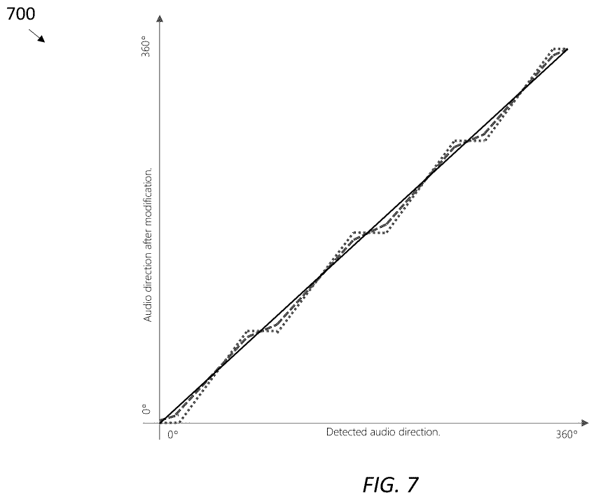

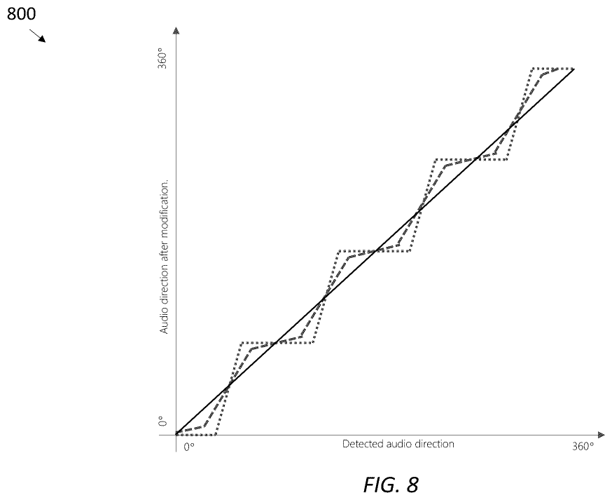

FIG. 7 shows an example graphical representation 700 of modification for sound direction for a sound source that is determined to be relatively closer to the cross-over point than the apparatus (compared to FIG. 8 which shows an example modification for sound direction for a sound source that is determined to be relatively closer to the apparatus than the cross-over point). The x-axis shows the captured spatial audio data from the sound source prior to any modification. The y-axis shows the modified spatial audio data after modification. The solid black represents the spatial audio data for a scenario in which no modification of the special audio data takes place (e.g. according to the prior art). Therefore, for the solid black line, there is no difference between the detected audio direction and the audio direction after modification. The dashed lines represent different implementation options for modifying the direction of the spatial audio data. The detected audio direction is modified according to a similar effect as used to transform the visual data. The audio direction is modified so that it is moved towards the closest blind spot centre. For example, a similar transformation path is used as shown in FIG. 5 to represent the transformation of the visual data to produce the stitched image.

FIG. 8 shows an example graphical representation 800 of modification for sound direction for a sound source that is a distance that relatively closer to the apparatus than the cross-over point. The x-axis shows the captured spatial audio data from the sound source prior to any modification. The y-axis shows the modified spatial audio data after modification. The solid black represents the spatial audio data for a scenario in which no modification of the special audio data takes place (e.g. according to the prior art).

Therefore, for the solid black line, there is no difference between the detected audio direction and the audio direction after modification. The dashed lines represent different implementation options for modifying the direction of the spatial audio data. The audio direction is modified so that it is moved towards the closest blind spot centre. The effect of this in FIG. 8 is more drastic than that shown in FIG. 7. The differences between FIG. 7 and FIG. 8 represent the differing implementation options for the amount of smoothing that is used.

For a sound source that is determined to be relatively closer to the apparatus than another sound source a larger degree of spatial audio data modification is required, as the sound source is closer to the apparatus. This is illustrated in FIG. 7 and FIG. 8, where the sound object is closer to the apparatus in FIG. 8 than in FIG. 7.

The method comprises an eight operation 608 of outputting the stitched image alongside the modified spatial audio data. A final output stitched image alongside the modified spatial audio data may be provided to a user.

### Modify Video Solution

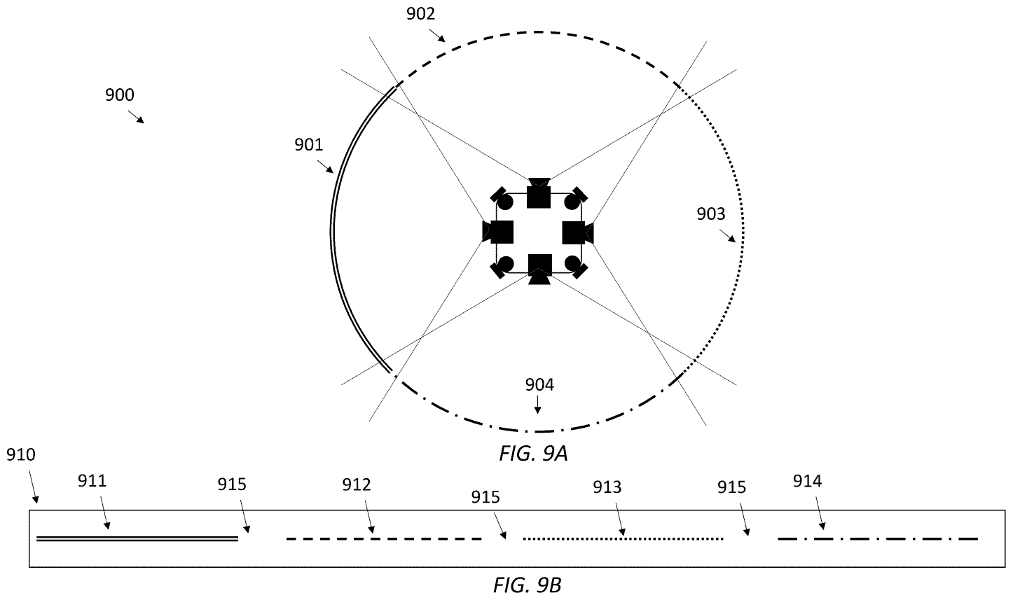

In the ‘modify video’ solution, the spatial audio data is not modified and instead the visual data part is modified to fit actual object directions. Instead of using typical stitching, the stitching of close by visual objects is done so that there will be “gaps” in the final image as illustrated in FIGS. 9A and 9B. These gaps are present only within a short distance from the 360-degree camera, before the cross-over point between adjacent cameras. Indeed, the gap represents the blind spot areas and is therefor only present within the distance from the camera where blind spot areas exist.

A final 360-degree camera image is generated by stitching together images from each of the cameras of a device 900. FIGS. 9A and 9B show how a stitched image may be generated from the example configuration discussed herein. By way of representation, fields of view of respective cameras are shown by the dotted and dashed lines in FIGS. 9A and 9B, in a similar format as shown in FIGS. 3A and 3B. In FIGS. 9A and 9B, the dotted and dashed lines sectors represent approximately how each camera image is used for a final 360-degree image, where field of views are shown as marked by the reference numerals 901-904 in FIG. 9A and the corresponding final image 910 is shown in FIG. 9B as stitched combination of the images taken in each field of view for each camera. Unlike in FIG. 3B, the stitched final image 910 is not produced by transforming the individually captured images from each of the cameras and instead gaps 915 are left in the stitched final image 910 to represent where the blind spot areas are present. This stitching mode is applied based on the distance of visual objects from the device. The image data from cameras is segmented based on visual object distances. The distances of the segments can be detected using several known methods such as depth map from a 3D camera (this requires the device cameras to be 3D), ultrasound proximity sensor, infrared proximity sensor.

It is noted that, typically, if an image segment is farther than the cross-over point, the stitching for those parts of the image does not have any gaps, since no blind spot areas are present and therefore there is no requirement to leave gaps in the stitched image.

However, the solution shown in FIGS. 9A and 9B is used if an image segment is closer than the cross-over point, since blind spot areas are present and therefore there is a desire to leave gaps in the image to account for the missing blind spot areas.

Where the object is closer than the cross-over point, it moves out from the field-of-view of both the camera sensors, disappearing into the blind spot between neighbouring camera sensors. The closer the object gets to the apparatus, the gap between neighbouring camera sensors increases, and the relative field-of-view of camera sensor images decreases. As the relative field-of-view of camera sensor images decrease, image distortion also decreases, and corresponding set of compensation parameters can be applied to allow best possible image quality. In this way, all image data in image segments which are close-by to the apparatus are closer to the corresponding image object original direction from the camera.

These gaps left in the stitched image can be both annoying and misleading because parts or a whole visual object disappears when it is moved to the blind spot area. The ‘modify video’ solution aims to counteract these gaps by filling them using the following method.

Firstly, when the image object is farther away than the cross-over point, the images from adjacent cameras overlap and thus the image data at camera edges correlates. Nothing needs to be done in these parts of the image.

However, when the image object is closer than the cross-over point, the camera images don't overlap and thus the image data at camera edges doesn't correlate. In these parts the gap area(s) may be filled with artificial image data. The artificial image data may be generated from machine learning methods, from data from a database or based on previously recorded image data from the apparatus. Non-correlating image features at camera image edges (i.e. at the edge of the field of view of the individual cameras) are used as a seed to look for suitable artificial image data to use as a fill. The fill may be the bigger the closer the visual object is to the apparatus, since the blind spot gap is bigger closer to the apparatus. Furthermore, previously recorded image data can alternatively and/or simultaneously be used as information to help fill the gap. For example, if a face has previously been fully visible in some camera sensor view, that information can be used to fill image when the face is only partially visible and partially hidden in the blind spot.

The gap area may also be filled dynamically based on the image content captured prior to the object distance has moved within the cross-over point, this can be done based on object detection models and motion tracking algorithms, where a moving object is detected and followed in the field of view of the camera. If the object moved into closer than the cross-over point, a highlighted filling content can be inserted to the gap area to indicate unnatural conditions of the scene in question. If there are supporting data available, e.g. audio or other sensory information, the location of the object within the cross-over point can be indicated in the gap area by an icon or marker. By inserting the image of the cropped or highlighted previously captured object, which is tracked to inside the cross-over point, the generated stitched image provides more realistic and continuous visual output. This becomes very meaningful when considering that the blind spot area could be significantly large.

Audio analysis can be used to categorise which object makes a sound close to the camera even when the visual object is completely hidden in the blind spot area. In some scenarios, a suitable icon can be selected by a user to be artificially added to the image in the direction of the sound object. The icon appearance may be preselected for each audio category. The size of the icon may depend on the sound object distance from the camera device.

It is noted that the example shown in FIGS. 9A and 9B shows a scenario where camera sensors are placed in the same vertical level. Another situation could be that the cameras are placed at different vertical levels, adding additional complexity to the gap existence and therefore the required image stitching, transformation parameter and algorithms. In the instance where different vertical camera levels need to be accounted for, this may be included in the transformation parameter in order to account for the different required stitching in this scenario. As such the details of exactly how the image stitching is performed, vary according to the actual positions of camera sensors (and audio microphones) in the apparatus.

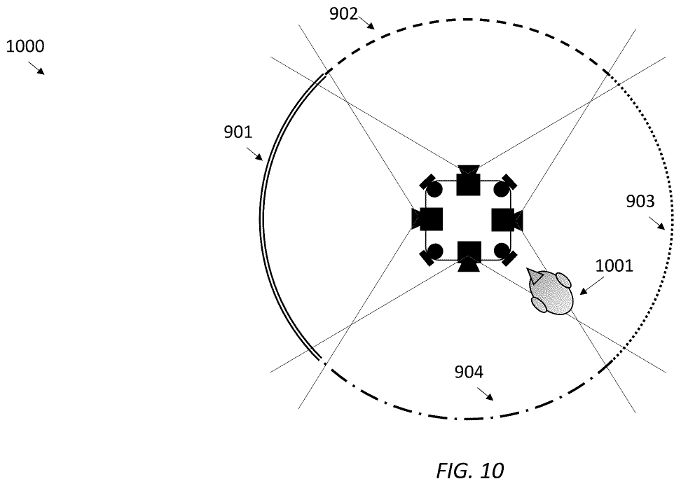

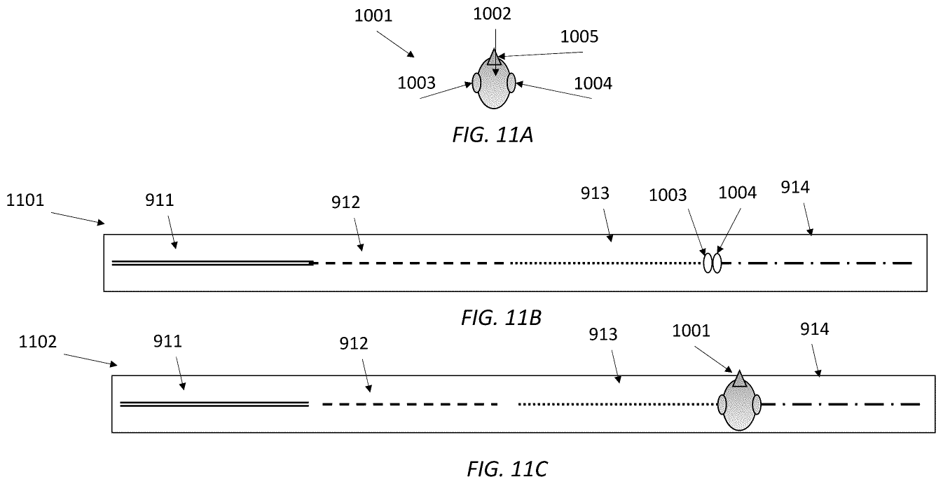

By way of example, FIG. 10 shows that a person 1001 has placed their head 1002 near the 360-degree camera apparatus 1000. FIG. 11 shows the person 1001 including their head 1002, two ears 1003, 1004 on either side of the head 1002 and a nose 1005. FIG. 11B shows a representation 1101 of stitched images on the basis of what is visible to the cameras. As demonstrated in FIG. 11B only the persons 1001 ears 1003, 1004 are seen by the camera sensors since the remainder of the head 1002 and nose 1005 is located in a blind spot area. As shown in FIG. 11B, prior art stitching would result in much of the person's head 1002 disappearing and only the ears 1003, 1004 being visible and touching each other. FIG. 11C shows a representation 1102 of stitched images including proposed visual data. As shown in FIG. 11C, the proposed solution includes generating proposed visual data to replace the gap between the ears. In this solution the person's 1001 ears 1003, 1004 are in the correct places and the gap between them is filled with artificial imagery. The background of the stitched image is unmodified.

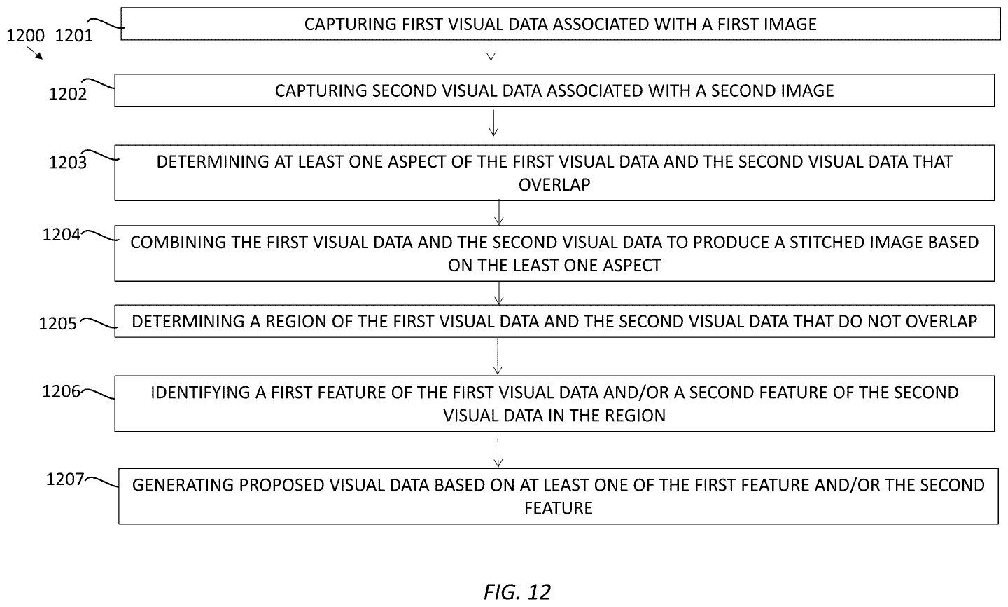

FIG. 12 shows, by way of example, a flowchart of a method according to example embodiments. Each element of the flowchart may comprise one or more operations. The operations may be performed in hardware, software, firmware or a combination thereof. For example, the operations may be performed, individually or collectively, by a means, wherein the means may comprise at least one processor; and at least one memory storing instructions that, when executed by the at least one processor, cause the performance of the operations.

The method 1200 of FIG. 12 may be carried out by an apparatus such as the device shown in FIGS. 1 to 4 and FIGS. 9 and 10. The apparatus may comprise a 360-degree camera. The apparatus may also include any panoramic or such cameras which utilize

stitching images from more than one image sensors.

The method 1200 comprises a first operation 1201 of capturing first visual data associated with a first image. The first visual data may be captured by camera 1 105 with field of view 109. The first image may comprise a still picture or video imagery.

The method 1200 comprises a second operation 1202 of capturing second visual data associated with a second image. The second image may comprise a still picture or video imagery. The second visual data may be captured by camera 2 106 with field of view 110. The field of view 109 and the field of view 110 have a cross over point 201 and there is a blind spot area 401 in an area proximate to the apparatus.

In some embodiments, the first visual data and second visual data may be collected via a single physical image sensor. The image sensor may be divided into more than one logical sensors, each having dedicated optics, which would result in stitching multiple images to form a single image.

The method 1200 comprises a third operation 1203 of determining at least one aspect of the first visual data and the second visual data that overlap. The method 1200 may include identifying at least one aspect of the imagery of the first visual data and the second visual data that match, for example, by identifying like features in the imagery. The at least one aspect may be a feature of the environment, a person or an animal by way of example. Determining at least one aspect of first visual data and second visual data that overlap is done for imagery that is farther away than the cross-over point. The images from adjacent cameras overlap and thus the image data at camera edges correlates. Overlapping means that the same aspect or feature is identified in both the first visual data and the second visual data.

The method 1200 comprises a fourth operation 1204 of combining the first visual data and the second visual data to produce a stitched image based on the least one aspect. The first visual data and the second visual data may be combined by using the at least one identified aspect that are considered to overlap in the first visual data and the second visual data. As such, a stitched image may be produced based on known identical aspects (identical features) in both the first visual data and the second visual data. An example of a stitched image based on based on least one aspect overlapping in first visual data and second visual data is shown in FIG. 11B.

The method 1200 comprises a fifth operation 1205 of determining a region of the first visual data and the second visual data that do not overlap. Not overlapping means that like aspects or features have not been identified in the first visual data and the second visual data. In other words, there may be a feature present in the first visual data that is not present in the second visual data, or vice versa.

In some scenarios, the region may comprise an area adjacent to a blind spot area of the apparatus. When portions of first visual data and second visual data are taken closer than the cross-over point, the camera images will likely not overlap due to the presence of blind spots for the adjacent cameras. As such, image data at camera edges doesn't correlate. Therefore, determining a region of the first visual data and the second visual data that do not overlap, comprises identifying aspects of the first visual data that are not present in the second visual data. This may be some alongside determining the region closest to or adjacent to the blind spot area. Determining the region closest or adjacent to the blind spot may comprise identifying portions of the first visual data and second visual data that are located directly next to blind spot areas. This may be achieved based on the angle of known blind spot areas based on the distance from the apparatus.

Alternatively, the region may be a separate area of the first visual data or second visual data that is not located near the blind spot. In this case a dynamic feature of the first visual data and/or second visual data may be identified based on motion detection. The dynamic feature may be located within a particular region of the first visual data or the second visual data. The dynamic feature may be tracked as it moves from being present in the first visual data to being present in the second visual data.

The method 1200 comprises a sixth operation 1206 of identifying a first feature of the first visual data and/or a second feature of the second visual data in the region. As such, the method 1200 may comprise identifying a first feature of the first visual data or identifying a second feature of the second visual data. Alternatively, the method may comprise identifying a first feature of the first visual data and identifying a second feature of the second visual data.

In some scenarios, by way of example, the first feature and the second feature could be the ears of a person, as demonstrated in FIGS. 10 and 11A-C. In this case, one ear 1003 is identified in the first visual data and another ear 1004 is identified the second visual data. The first feature and second feature could also be features of the environment, such as the leaf of a tree, or features of any animal such as a tail or nose. In situations where only a first feature is identified, then, by way of example, only one ear of a person may be identified in the first visual data.

Alternatively, in some scenarios, identifying a first feature of the first visual data and/or a second feature of the second visual data in the region may comprise identifying the dynamic feature of the first visual data and/or second visual data identified based on motion detection. This can be done based on object detection models, where a moving object is detected and followed in the field of view of a camera. If the object moved into closer than the cross-over point, a highlighted filling content can be inserted to the gap area to indicate unnatural conditions of the scene in question. This may flag to a user that there is a missing feature which may have moved into a blind spot of the apparatus.

The method 1200 comprises a seventh operation 1207 of generating proposed visual data based on at least one of the first feature and/or the second feature. The proposed visual data may be generated based on a machine learning model, from data from a database or based on previously recorded image data from the apparatus. The machine learning model may have been trained in the same or a similar environment to which the current first visual data and second visual data have been captured. The previously recorded image data could be recent image data. For example, the previously recorded image data could include a feature which is disappearing and reappearing from view such as an animal or person.

The method 1200 may optionally comprise updating the stitched image to include the proposed visual data. Updating the stitched image, may include incorporating the proposed visual data adjacent to the identified first and/or second feature. For example, where a stationary feature is identified in the region that is close to a blind spot this will be incorporated within the blind spot area. In the case of the first or second feature being a dynamic object, updating the stitched image, may include incorporating the proposed visual data in a different area to where the dynamic object was identified. For example, the dynamic object could be placed within the blind spot region when it is determined that the object is otherwise out of view. Updating the stitched image to include the proposed visual data may take place in the same way as described in the example scenario of FIGS. 10 and 11.

The method 1200 may optionally comprise capturing spatial audio data from a sound source and generating the proposed visual data based on the spatial audio data. Audio analysis can be used to categorise an object that makes a sound close to the camera even when the visual object is completely hidden in the blind spot area. In this scenario, the proposed visual data can be determined based on the known audio object in the blind spot area. In some scenarios, a suitable icon can be selected by a user to be artificially added to the stitched. This icon may be selected from a database of suitable icons for the audio data detected. The icon may be added to the stitched image in the direction of that the sound object is identified to be in. The icon appearance may be preselected for each audio category. The size of the icon may depend on the sound object distance from the camera device.

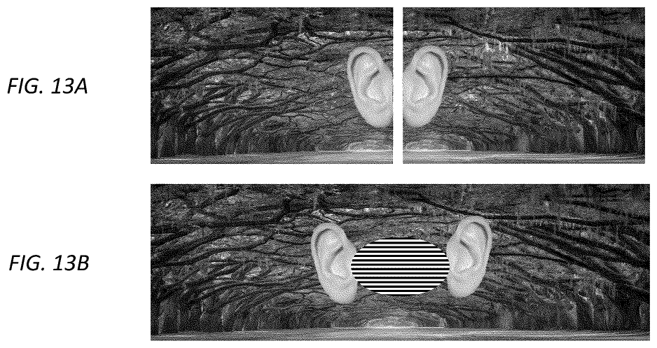

FIG. 13 demonstrates an example situation covered by the proposed method. FIG. 13A shows original first visual data associated with a first image and second visual data associated with a second image. A background forest may be segmented to its own segment and ears to their own segments based on distance from camera. As such, the background forest and ears are treated as unique features within the first image and the second image. The background forest segments from the first image data and the second image data overlap at camera edge and a stitched image can be produced based on the background forest elements that overlap. The ear segments don't overlap, and this indicates that ear segments may be located adjacent to a blind spot area. As shown, in FIG. 13B the ear segments are then stitched differently leaving a gap where the gap width depends on the distance of the ears from the camera. The stitching is done based on the background forest rather than the eyes, and a gap is left for between the ears, based on the expected missing area caused by the blind spot. The gap may then be filled with artificial imagery. The artificial imagery is designed to hide problems arising from the different stitching of the ears, like filling the void that is in the place from which the ears were moved.

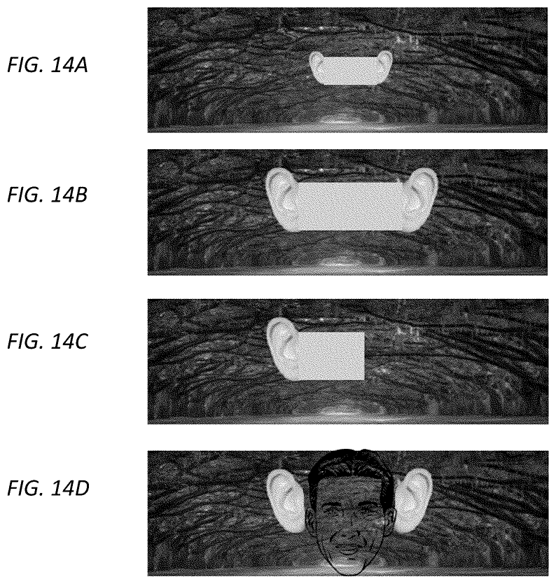

FIGS. 14A and 14B show gaps of varying sizes which may be filled with artificial imagery. The varying gap sizes may depend on the distance within the cross over point of the image object to the apparatus (e.g. the closer the object, the bigger the gap). The varying size gaps may therefore also depend on the size of non-overlapping segments in the original camera sensor image edges. For example, the size of the ears dictates the rough size of the artificial imagery that may be required to fill the gaps. If only small ears are detected (as shown in FIG. 14A) then a smaller gap is estimated to be required to be filled with artificial imagery as the remainder of a persons face is determined to be in keeping with the size of the ears. If relatively larger ears are detected (as shown in FIG. 14B) then are larger gap is estimated to be required to be filled with artificial imagery to be in keeping with the size of the ears. Therefore, generation of proposed visual data may be based on the size of the identified features in camera imagery. Other features such as colour, shape, specific patterning may also be used to generate the proposed visual data.

FIG. 14C shows the scenario when a non-overlapping feature is detected in only one of first visual data or second visual data. In this scenario, there is only the single feature which can be used to aid the determination of the proposed visual data. The single feature can be used alone to determine proposed visual data, e.g. based on size and positioning. This is advantageous when only one piece of information is available to determine the proposed visual data. The method may extrapolate proposed visual data based on further available information from a machine learning model, database repository or audio information.

FIG. 14D shows how artificial imagery may be made to match recognized features of the non-overlapping segments. A machine learning model may, for example, search based on the type of ears as shown in the visual data and pick proposed visual data based on the information available (such as size, shape and relative positioning). The artificial imagery may also include producing suitable background imagery to match the background imagery present in other areas of the captured visual data. In the example in FIG. 14D the background forest area is shown as filling in the background of the proposed visual data.

### Combined ‘Modify Video’ and ‘Modify Audio’ Solution

It is also possible in some embodiments to combine the ‘Modify Video’ and ‘Modify Audio’ solutions so that both are used. For example, the audio directions are modified by a part e.g. half of the needed azimuth (and elevation) angles and the rest is taken care of by moving visuals.

As such, both the methods of FIG. 6 and FIG. 12 may be used simultaneously to create an improved user experience with a 360-degree camera device.

### Example Apparatus

FIG. 15 shows an apparatus according to some example embodiments, which may comprise a controller of a 360-degree camera device 100 of FIG. 1. The apparatus may be configured to perform the operations described herein, for example operations described with reference to any disclosed process. The apparatus comprises at least one processor 1500 and at least one memory 1501 directly or closely connected to the processor. The memory 1501 includes at least one random access memory (RAM) 1501a and at least one read-only memory (ROM) 1501b. Computer program code (software) 1505 is stored in the ROM 1501b. The apparatus may be connected to a transmitter (TX) and a receiver (RX). The apparatus may, optionally, be connected with a user interface (UI) for instructing the apparatus and/or for outputting data. The at least one processor 1500, with the at least one memory 1501 and the computer program code 1505 are arranged to cause the apparatus to at least perform at least the method according to any preceding process, for example as disclosed in relation to the flow diagrams of FIG. 6, FIG. 12 and related features thereof.

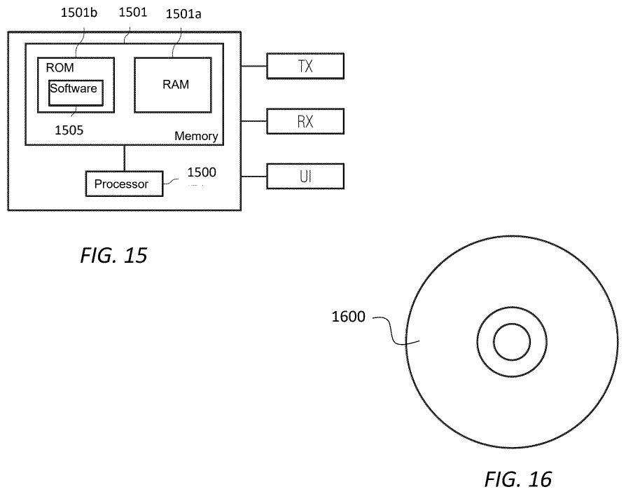

FIG. 16 shows a non-transitory media 1600 according to some embodiments. The non-transitory media 1600 is a computer readable storage medium. It may be e.g. a CD, a DVD, a USB stick, a blue ray disk, etc. The non-transitory media 1600 stores computer program code, causing an apparatus to perform the method of any preceding process for example as disclosed in relation to the flow diagrams and related features thereof.

Names of network elements, protocols, and methods are based on current standards. In other versions or other technologies, the names of these network elements and/or protocols and/or methods may be different, as long as they provide a corresponding functionality. For example, embodiments may be deployed in 2G/3G/4G/5G networks and further generations of 3GPP but also in non-3GPP radio networks such as WiFi.

A memory may be volatile or non-volatile. It may be e.g. a RAM, a SRAM, a flash memory, a FPGA block ram, a DCD, a CD, a USB stick, and a blue ray disk.

If not otherwise stated or otherwise made clear from the context, the statement that two entities are different means that they perform different functions. It does not necessarily mean that they are based on different hardware. That is, each of the entities described in the present description may be based on a different hardware, or some or all of the entities may be based on the same hardware. It does not necessarily mean that they are based on different software. That is, each of the entities described in the present description may be based on different software, or some or all of the entities may be based on the same software. Each of the entities described in the present description may be embodied in the cloud.

Implementations of any of the above-described blocks, apparatuses, systems, techniques or methods include, as non-limiting examples, implementations as hardware, software, firmware, special purpose circuits or logic, general purpose hardware or controller or other computing devices, or some combination thereof. Some embodiments may be implemented in the cloud.

It is to be understood that what is described above is what is presently considered the preferred embodiments. However, it should be noted that the description of the preferred embodiments is given by way of example only and that various modifications may be made without departing from the scope as defined by the appended claims.

1-16. (canceled)

17. An apparatus comprising:
at least one processor; and
at least one memory storing instructions that, when executed by the at least one processor, cause the apparatus at least to:
capture first visual data associated with a first image;
capture second visual data associated with a second image;
determine at least one aspect of the first visual data and the second visual data that overlap;
combine the first visual data and the second visual data to produce a stitched image based on the least one aspect;
determine a region of the first visual data and the second visual data that do not overlap;
identify at least one of a first feature of the first visual data or a second feature of the second visual data in the region; and
generate proposed visual data based on at least one of the first feature or the second feature.

18. The apparatus of claim 17, wherein the apparatus is further caused to update the stitched image to include the proposed visual data.

19. The apparatus of claim 17, wherein the apparatus is further caused to:
capture spatial audio data from a sound source; and
generate the proposed visual data based on the spatial audio data.

20. The apparatus of claim 17, wherein the proposed visual data is generated by a machine learning model or a database repository.

21. The apparatus of claim 17, wherein the proposed visual data is generated based on previous imagery captured in the region.

22. The apparatus of claim 17, wherein the region comprises an area adjacent to a blind spot area of the apparatus.

23. The apparatus of claim 17, wherein the apparatus comprises a 360-degree camera.

24. A method, comprising:
capturing first visual data associated with a first image;
capturing second visual data associated with a second image;
determining at least one aspect of the first visual data and the second visual data that overlap;
combining the first visual data and the second visual data to produce a stitched image based on the least one aspect;
determining a region of the first visual data and the second visual data that do not overlap;
identifying a first feature of the first visual data and/or a second feature of the second visual data in the region; and
generating proposed visual data based on at least one of the first feature and/or the second feature.

25. The method of claim 24, further comprising updating the stitched image to include the proposed visual data.

26. The method of claim 24, further comprising:
capturing spatial audio data from a sound source; and
generating the proposed visual data based on the spatial audio data.

27. The method of claim 24, wherein the proposed visual data is generated by a machine learning model or a database repository.

28. The method of claim 24, wherein the proposed visual data is generated based on previous imagery captured in the region.

29. The method of claim 24, wherein the region comprises an area adjacent to a blind spot area of the apparatus.

30. The method of claim 24, wherein the apparatus comprises a 360-degree camera.

31. A non-transitory computer readable medium comprising program instructions stored thereon for performing at least the following:
capturing first visual data associated with a first image;
capturing second visual data associated with a second image;
determining at least one aspect of the first visual data and the second visual data that overlap;
combining the first visual data and the second visual data to produce a stitched image based on the least one aspect;
determining a region of the first visual data and the second visual data that do not overlap;
identifying a first feature of the first visual data and/or a second feature of the second visual data in the region; and
generating proposed visual data based on at least one of the first feature and/or the second feature.
